(19) United States
(12) Patent Application Publication
(10) Pub. No.: US 2011/0154637 A1
(43) Pub. Date: Jun. 30, 2011

(54) Assembling Method and Structure of Optical Disc Drive

(75) Inventors: Ming-Chao Lee, Taipei City (TW); Chien-Hsun Chen, Taipei City (TW)

(73) Assignee: LITE-ON IT CORPORATION, Taipei City (TW)

(21) Appl. No.: 12/764,269

(22) Filed: Apr. 21, 2010

(30) Foreign Application Priority Data
Dec. 28, 2009 (CN) 200910265613.7

(51) Int. Cl. B23P 17/04

(52) U.S. Cl. 29/428; 29/281.1

(57) ABSTRACT

An assembling structure of an optical disc drive is provided to comprise a chassis, for supporting a tray, wherein the tray is used for loading and unloading an optical disc, and the chassis has an assembling recess horizontally disposed at side of the chassis and positioned under the tray; a top cover, having an assembling element accommodated in the assembling recess of the chassis; and a bottom cover, positioned under the chassis and assembled to the top cover.

This application claims the benefit of People's Republic of China application Serial No. 200910265613.7, filed Dec. 28, 2009, the subject matter of which is incorporated herein by reference.

### BACKGROUND OF THE INVENTION

1. Field of the Invention

The invention relates in general to an assembling method and structure of an optical disc drive, and more particularly to an assembling method and structure of a top cover, a bottom cover and a chassis of the optical disc drive.

2. Description of the Related Art

In the beginning, the optical disc drive is designed to be installed in the computer, and the optical disc drive has a standard size in this industry for being compatible with the computer. Recently, according to the development of the implementation of the optical disc drive, the optical disc drive may be installed in various consumer products not only in the computer. However, the size of the optical disc drive installed in the other consumer products is still a standard one. It is because that, based on the same size of optical disc drive, the optical disc drive manufacturer can use the same design to manufacture the optical disc drive for various implementations for saving a large cost of design change.

However, the size of the consumer product is smaller in order to raise the competition position in the market. In other words, the size of the optical disc drive for installing in the consumer product needs to be smaller than that for installing in the computer. It means that the design change of the optical disc drive can not be avoided. Therefore, how to reduce the size of the optical disc drive with less cost is an important project in this industry.

Please refer to FIG. 1 and FIG. 2. FIG. 1 is an explosive view of a traditional optical disc drive 100, and FIG. 2 is a cross-section view of the traditional optical disc drive 100. The optical disc drive 100 comprises a top cover 110, a bottom cover 120, a chassis 130 and a tray 140. The chassis 130 is used for supporting internal elements needed in the optical disc drive 100, for example a optical pickup head, a spindle motor, a PCB plate and so on. The tray 140 is moveably installed on the chassis for loading/unloading an optical disc 150.

In general, the width of the tray 140 and the width of the optical disc 150 are approximately equal, and the smallest width of the chassis 130 may design to be a little larger than the width of the tray 140 as the width D shown in FIG. 2. However, in the traditional optical disc drive, in order to assemble the top cover 110, bottom cover 120 and the chassis 130 together, a locking space 131 is outwardly extended from both sides of the chassis 130, and the bottom of the locking space 131 has a plural of locking holes 132. Relatively, a plural of locking elements 111 are inwardly extended from both sides of the top cover 110, and each locking element 111 has a locking hole formed on which. Also, the bottom cover 120 comprises a plural of locking holes 121. The above mentioned locking holes 132, 111 and 121 are related to each other and locked by screws 160 for assembling the top cover 110, bottom cover and the chassis together.

As shown in FIG. 2, because the locking space 131 are outwardly extended from the two sides of the chassis 130, the width of the traditional optical disc drive as a whole should further add the width L of the locking space 131. Accordingly, though the assembling design of the traditional optical disc drive has been used for a long time, it should be changed for being compatible with the consumer products, which have small size, in order to raise the competition position in the market.

### SUMMARY OF THE INVENTION

Accordingly, the invention provides an assembling method and structure of an optical disc drive that can efficiently reduce the width of the optical disc drive without changing the design of the internal elements of the optical disc drive and raise the competition position of the optical disc drive in the market.

According to a first aspect of the present invention, an assembling structure of an optical disc drive is provided to comprise a chassis, for supporting a tray, wherein the tray is used for loading and unloading an optical disc, and the chassis has an assembling recess horizontally disposed at side of the chassis and positioned under the tray; a top cover, having an assembling element accommodated in the assembling recess of the chassis; and a bottom cover, positioned under the chassis and assembled to the top cover.

According to a second aspect of the present invention, an assembling method of an optical disc drive is provided. The optical disc drive has a chassis, a top cover and a bottom cover, and the assembling method comprises steps of: assembling the top cover to the chassis by horizontally moving the top cover related to the chassis; and assembling the bottom cover to the chassis and the top cover by upwardly moving the bottom cover related to the chassis and the top cover.

### BRIEF DESCRIPTION OF THE DRAWINGS

The invention will become apparent from the following detailed description of the preferred but non-limiting embodiments. The following description is made with reference to the accompanying drawings.

FIG. 1 is an explosive view of a traditional optical disc drive;

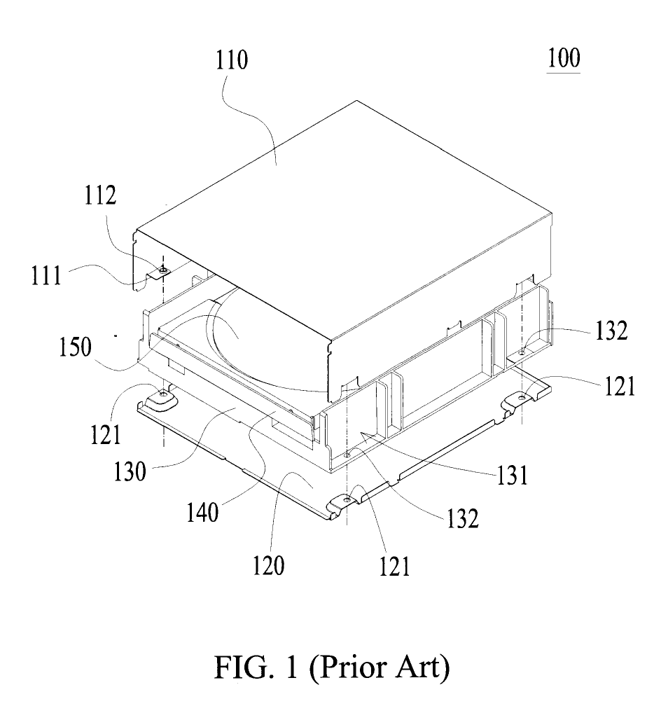

FIG. 2 is a cross-section view of the traditional optical disc drive;

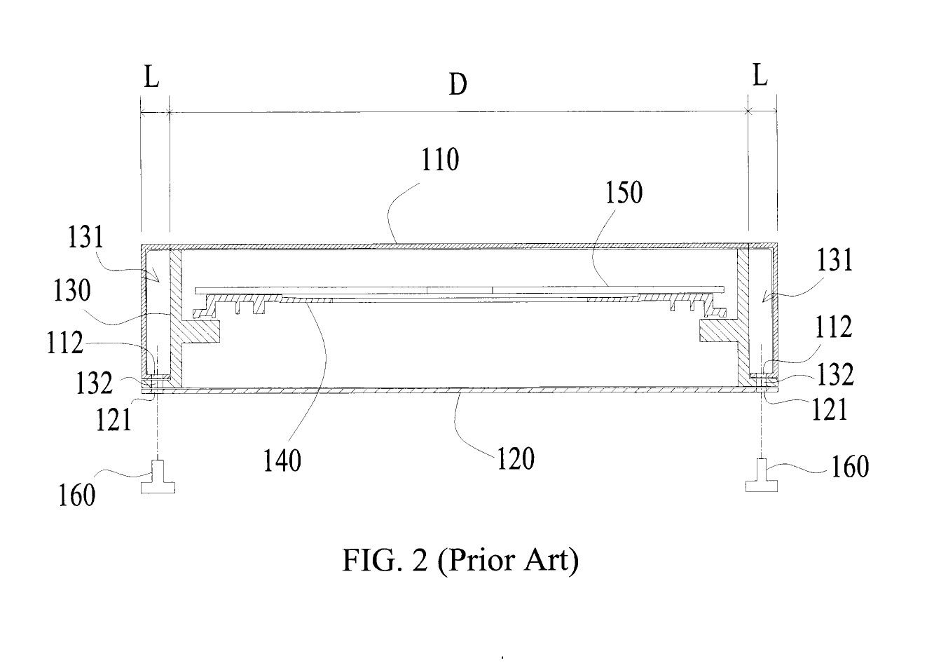

FIG. 3 is an explosive view of an optical disc drive according to a preferred embodiment of the present invention;

FIG. 4 is a cross-section view of an optical disc drive according to the preferred embodiment of the present invention;

FIG. 5 shows the top cover and the chassis during the assembling process according to the preferred embodiment of the present invention;

FIG. 6 shows the top cover and the chassis after completing the assembling process according to the preferred embodiment of the present invention;

FIG. 7 shows the completed assembly shown in FIG. 6 and the bottom cover during the assembling process according to the preferred embodiment of the present invention;

FIG. 8 shows the top cover, the chassis and the bottom cover after completing the assembling process according to the preferred embodiment of the present invention.

### DETAILED DESCRIPTION OF THE INVENTION

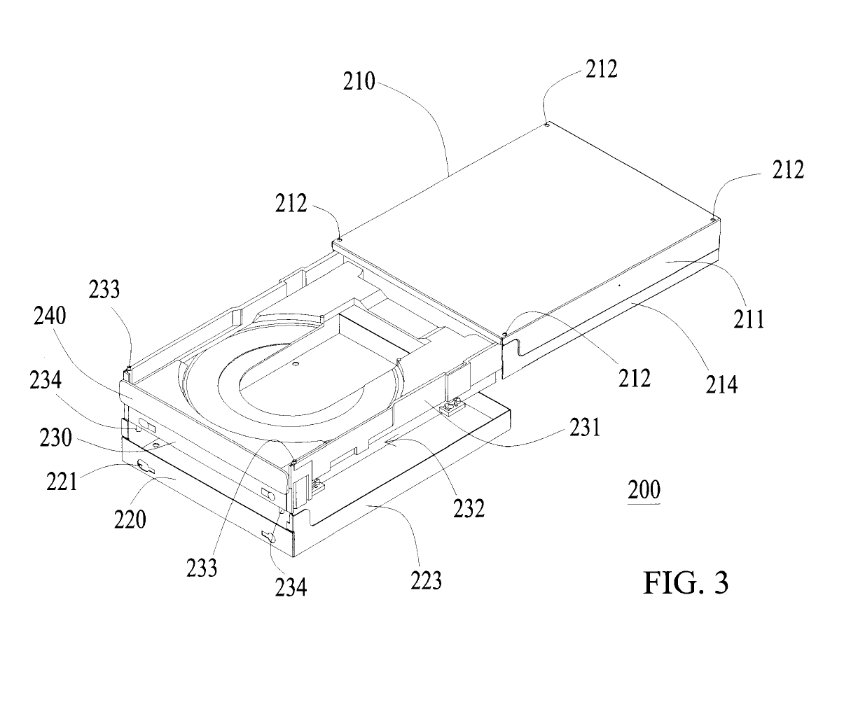

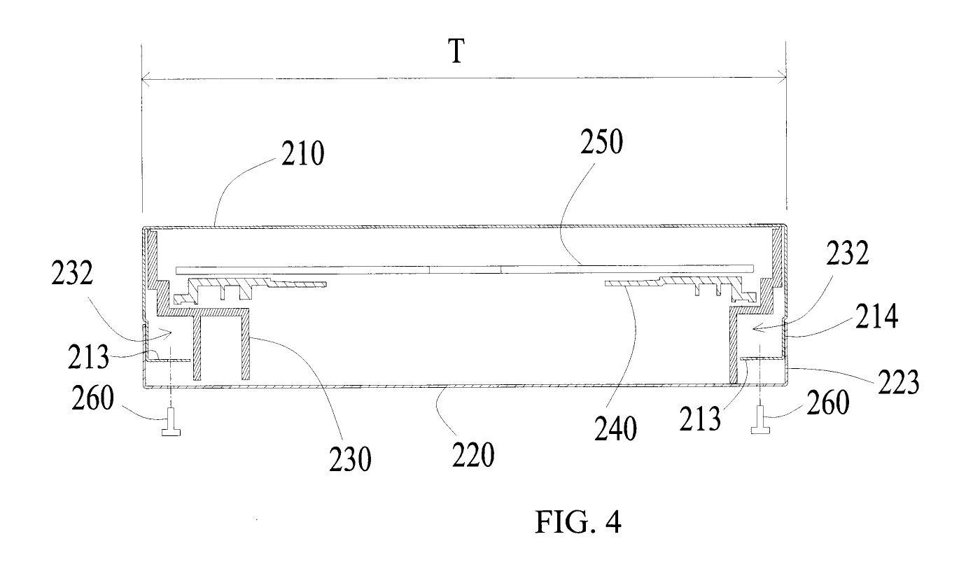

Please refer to FIG. 3 and FIG. 4, which respectively show an explosive view and a cross-section view of an optical disc drive 200 according to a preferred embodiment of the present invention. The present invention provides an optical disc drive 200 which comprises a top cover 210, a bottom cover 220, a chassis 230 and a tray 240. The chassis 230 is used for supporting internal elements, for example an optical pick-up head, a spindle motor, a PCB plate and so on, of the optical disc drive 200. The tray 240 is moveably disposed on the chassis 230 for loading and unloading an optical disc 250. The chassis 230 has assembling recesses 232 horizontally disposed at two sides of the chassis 230, and the assembling recesses 232 are located under the tray 240. The top cover 210 has side walls 211 and assembling elements 213. The assembling elements 213 are internal extended from the side walls 211 of the top cover 210, and the assembling elements 213 are relatively accommodated in the assembling recesses 232 of the chassis 230.

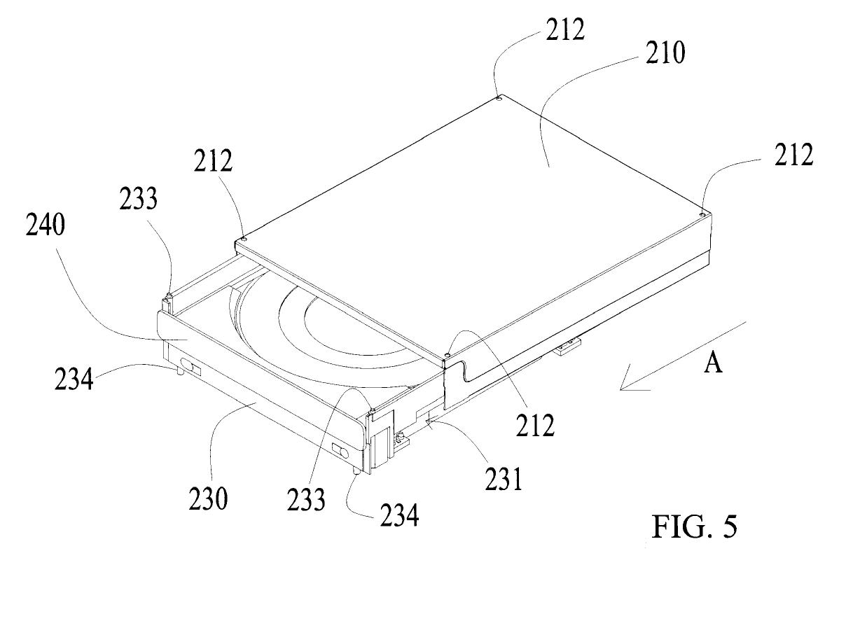

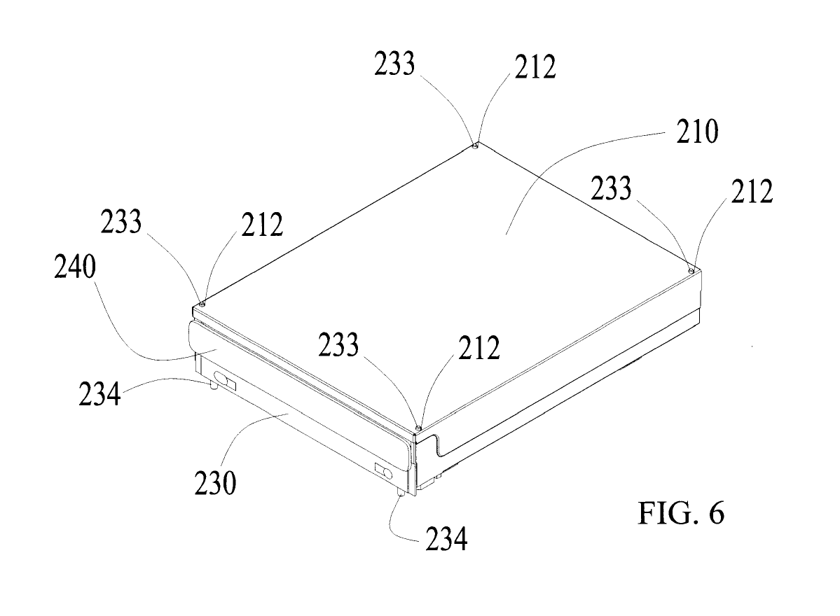

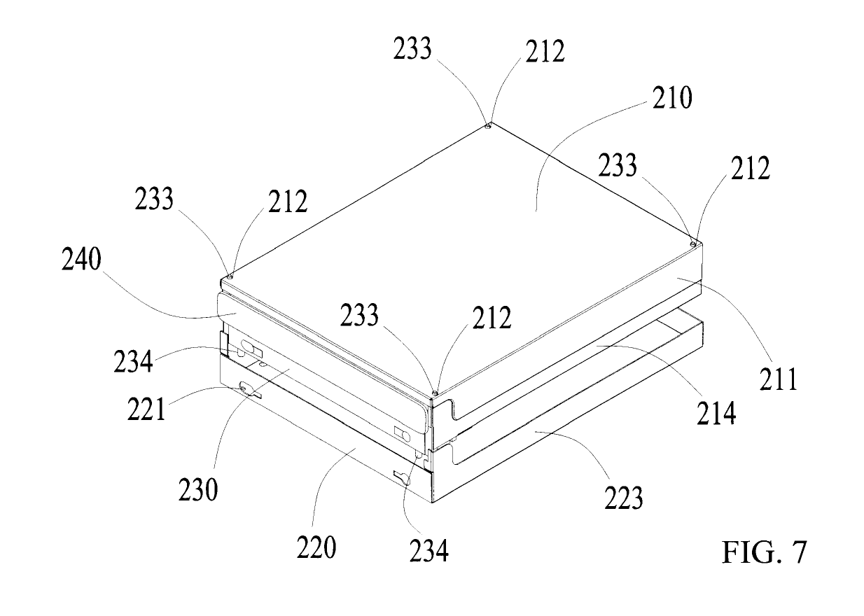

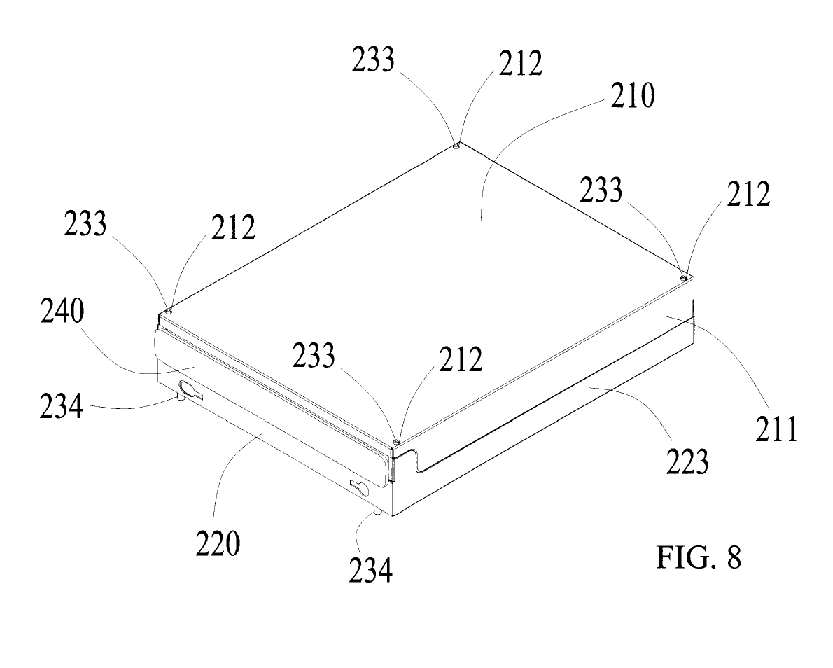

Please refer to FIG. 5 to FIG. 8. FIG. 5 shows the top cover 210 and the chassis 230 during the assembling process according to the preferred embodiment of the present invention. FIG. 6 shows the top cover 210 and the chassis 230 after completing the assembling process according to the preferred embodiment of the present invention. FIG. 7 shows the completed assembly shown in FIG. 6 and the bottom cover 220 during the assembling process according to the preferred embodiment of the present invention. FIG. 8 shows the top cover 210, the chassis 230 and the bottom cover 220 after completing the assembling process according to the preferred embodiment of the present invention.

The present invention further provides an assembling method of an optical disc drive 200. First, the top cover 210 is assembled to the chassis 230 by horizontally moving the top cover 210 related to the chassis 230. At that time, the assembling elements 213 are relatively moved in the assembling recesses 232. As shown in FIG. 5, the top cover 210 is moved from the back side to the front side of the chassis 230 along the arrow A. The completed assembly of the top cover 210 and the chassis 230 is shown in FIG. 6. Then, the bottom cover 220 is assembled to the completed assembly of the top cover 210 and the chassis 230 by upwardly moving the bottom cover 220 related to the completed assembly of the top cover 210 and the chassis 230 as shown in FIG. 7. Moreover, a plurality of crews 260 can be used to screw the bottom cover 220 to the completed assembly of the top cover 210 and the chassis 230. The final completed assembly of the top cover 210, the chassis 230 and the bottom cover 220 is shown in FIG. 8.

The optical disc drive 200 according to the present invention, the assembling recesses 232 are located under the tray 240 so that the assembling space of the top cover 210, the chassis 230 and the bottom cover 220 is located under the tray 240 too. Therefore, the width of the optical disc drive 200 as a whole according to the present invention is reduced, and the width T of the optical disc drive as shown in FIG. 4 can be designed to have a smallest width as the width of the tray 240.

Please refer to FIG. 3 again. The chassis 230 of the optical disc drive 200 according to the present invention further comprises a plurality of positioning pillars 233, 234, and the top cover 210 and the bottom cover 220 can respectively have a plurality of positioning holes 212, 221 related to the positioning pillars 233, 234 of the chassis 230.

Please refer to FIG. 5 and FIG. 6. When the assembling elements 213 of the top cover 210 moves forward along the assembling recesses 232 of the chassis 230 and to cover the top of the chassis 230, the top cover 210 further downwardly moves related to the chassis 230 so that the positioning pillars 233 of the chassis 230 are engages with related positioning holes 212 of the top cover 210 as show in FIG. 7 and FIG. 8.

Please refer to FIG. 3 again. The bottom cover 220 of the optical disc drive according to the present invention further comprises side walls 223, and the side walls 211 of the top cover 210 have depression step 214 for accommodating the side walls 223 of the bottom cover 220. Please refer to FIG. 4, FIG. 7 and FIG. 8. when the bottom cover 220 is assembled to the top cover 210 and the chassis 230, the side walls 223 of the bottom cover 220 are accommodated in the depression step 214 of the top cover 210 as shown in FIG. 4 and FIG. 8.

According to the optical disc drive and its assembling method of the present invention, it can efficiently reduce the width of the optical disc drive without changing the design of the internal elements, therefore, improving the marketing competition.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An assembling structure of an optical disc drive comprising:
a chassis, for supporting a tray, wherein the tray is used for loading and unloading an optical disc, and the chassis has an assembling recess horizontally disposed at side of the chassis and located under the tray;
a top cover, having an assembling element accommodated in the assembling recess of the chassis; and
a bottom cover, positioned under the chassis and assembled to the top cover.

2. The assembling structure of the optical disc drive according to claim 1, wherein the bottom cover is assembled to the top cover by at least a screw.

3. The assembling structure of the optical disc drive according to claim 1, wherein the chassis has at least a positioning pillar, and the top cover has at least a positioning hole related to the positioning pillar of the chassis.

4. The assembling structure of the optical disc drive according to claim 1, wherein the chassis has at least a positioning pillar, and the bottom cover has at least a positioning hole related to the positioning pillar of the chassis.

5. The assembling structure of the optical disc drive according to claim 1, wherein the side wall of the top cover has a depression step for accommodating the side wall of the bottom cover.

6. An assembling method of an optical disc drive, wherein the optical disc drive has a chassis, a top cover and a bottom cover, the assembling method comprises steps of:
assembling the top cover to the chassis by horizontally moving the top cover related to the chassis; and
assembling the bottom cover to the chassis and the top cover by upwardly moving the bottom cover related to the chassis and the top cover.

7. The assembling method of the optical disc drive according to claim 6, wherein the step of assembling the top cover to the chassis further comprises assembling the top cover to the chassis by horizontally moving the top cover from the back side to the front side of the chassis.

8. The assembling method of the optical disc drive according to claim 6, wherein the chassis has an assembling recess, and the top cover has an assembling element, wherein when assembling the top cover to the chassis by horizontally moving the top cover related to the chassis, the assembling element horizontally moves in the assembling recess.

9. The assembling method of the optical disc drive according to claim 6, further comprising a step of assembling the top cover to the chassis by downwardly moving the top cover related to the chassis after horizontally assembling the top cover to the chassis.

10. The assembling method of the optical disc drive according to claim 9, wherein the chassis has at least a positioning pillar, and the top cover has at least a positioning hole, wherein when assembling the top cover to the chassis by downwardly moving the top cover related to the chassis, the positioning hole is assembled to the positioning hole.
